(19) United States
(12) Patent Application Publication
(10) Pub. No.: US 2014/0214365 A1
(43) Pub. Date: Jul. 31, 2014

(54) METHOD FOR THE DIAGNOSTIC ANALYSIS OF A HEATING, VENTILATION AND AIR-CONDITIONING SYSTEM (HVAC)

(71) Applicant: Schneider Electric Industries SAS, Rueil Malmaison (FR)

(72) Inventor: Christophe LIGERET, Grenoble (FR)

(73) Assignee: Schneider Electric Industries SAS, Rueil Malmaison (FR)

(21) Appl. No.: 14/163,421

(22) Filed: Jan. 24, 2014

(30) Foreign Application Priority Data
Jan. 28, 2013 (FR) 13 50693

(51) Int. Cl. G01M 99/00

(52) U.S. Cl. CPC G01M 99/005
USPC 702/183

(57) ABSTRACT

The invention relates to a method for the diagnostic analysis of a heating, ventilation and air-conditioning system (HVAC), comprising at least one compressor (Comp) connected to an air condenser (Cond) and designed for the circulation of a coolant fluid (Ff), an evaporator (Ev) connected to the air condenser (Cond) via a expansion device (Det) and permeated by a heat transfer fluid (Fc), wherein said air condenser comprises at least one ventilator (Vent). Said method permits the determination of enthalpies in the system at the compressor intake, the compressor discharge, the inlet to the expansion device and the outlet of the expansion device, together with the superheating of the system, using only three temperature measurements and the command function of the compressor.

### TECHNICAL FIELD OF THE INVENTION

The present invention relates to a method for the diagnostic analysis of a heating, ventilation and air-conditioning system (HVAC).

### PRIOR ART

For the maintenance of a heating, ventilation and air-conditioning system, more commonly described as an HVAC system (an abbreviation for “Heating, Ventilation and Air-Conditioning”), it is now necessary to observe certain critical variables in real time, and to undertake statistical analyses for the execution of an advanced diagnostic procedure. In many cases, current solutions available are complex to apply, and specifically require the use of large numbers of sensors and the modification of the structure of the system in order to accommodate the installation of sensors.

The object of the invention is to propose a method for the execution of an accurate diagnostic analysis of the operation of a heating, ventilation and air-conditioning system (HVAC), using a minimum of sensors and executed in a non-intrusive manner. More specifically, the solution according to the invention does not involve the use of flow meters, pressure sensors or electric power sensors.

### DESCRIPTION OF THE INVENTION

This object is achieved by a diagnostic analysis method for a heating, ventilation and air-conditioning system, wherein said system comprises at least one compressor, connected to an air condenser and designed for the circulation of a coolant fluid, an evaporator connected to the air condenser via an expansion device and permeated by a heat transfer fluid, said air condenser comprising at least one ventilator, wherein said method involves:
Measuring:
   the coolant fluid temperature at the compressor intake,
   the coolant fluid temperature at the inlet to the expansion device,
   the coolant fluid temperature at the outlet of the expansion device,
determining or measuring of the discharge temperature of the compressor, and
determining on the basis of temperature measurements at the compressor intake, at the inlet of the expansion device and at the outlet of the expansion device, of the measured or estimated discharge temperature of the compressor, of the compressor command function and of a thermodynamic module:
enthalpies of the system at the compressor intake, at the compressor discharge, at the inlet of the expansion device and at the outlet of the expansion device,
the superheating of the system.

According to a particular feature, the method involves the determination of the sub-cooling of the system on the basis of temperature measurements at the compressor intake, at the compressor discharge, at the inlet of the expansion device, at the outlet of the expansion device, and of the determined enthalpies.

According to a further particular feature, the method involves the determination of the value for low pressure and the value for high pressure which are characteristic of the enthalpic diagram of the system, on the basis of temperature measurements at the compressor intake, at the inlet to the expansion device, at the outlet of the expansion device, of the determined enthalpies and of the estimated or measured discharge temperature of the compressor.

According to a further particular feature, the method involves a stage for the determination of the flow rate of coolant fluid through the compressor on the basis of the volumetric mass of the coolant fluid, of the compressor command function, and of a function for the high pressure value and the low pressure value. According to a further particular feature, the method involves a stage for the determination of the thermal capacity of the condenser, and of the thermal capacity of the evaporator, on the basis of the flow rate of coolant fluid and the enthalpies determined at the four points of measurement.

According to a further particular feature, the method involves a stage for the determination of the electric power input of the compressor, on the basis of the flow rate of coolant fluid and of the determined enthalpies.

According to a further particular feature, the method involves a stage for the determination of the electric power input of each ventilator in the air condenser, on the basis of the command function applied to each ventilator.

According to a further particular feature, the method involves a stage for the determination of the electric power input of each pump used for the circulation of the heat transfer fluid, on the basis of the command function applied to each pump.

According to a further particular feature, the method involves a stage for the determination of an instantaneous performance coefficient on the basis of the thermal capacity of the system and of the electrical capacity of the system.

The invention also relates to a system for the diagnostic analysis of a heating, ventilation and air-conditioning system, wherein said system comprises at least one compressor, connected to an air condenser and designed for the circulation of a coolant fluid, an evaporator connected to the air condenser via an expansion device and permeated by a heat transfer fluid, said air condenser comprising at least one ventilator, said system being comprised of the following:
a temperature sensor for the coolant fluid at the compressor intake,
a temperature sensor for the coolant fluid at the compressor discharge,
a temperature sensor for the coolant fluid at the inlet to the expansion device,
a temperature sensor for the coolant fluid at the outlet of the expansion device,
a command and processing unit, comprising a thermodynamic module which is arranged for the determination of the following, on the basis of temperature measurements and of the command function of the compressor:
   enthalpies of the system at the four temperature measuring points,
   the superheating of the system.

According to a particular feature, the thermodynamic module is arranged for the determination of the sub-cooling of the system on the basis of temperature measurements at the compressor intake, at the compressor discharge, at the inlet of the expansion device, at the outlet of the expansion device, and of the determined enthalpies.

According to a further particular feature, the thermodynamic module is arranged for the determination of the value for low pressure and the value for high pressure which are characteristic of the enthalpic diagram of the system, on the basis of temperature measurements at the compressor intake, at the inlet to the expansion device, at the outlet of the expansion device, of the enthalpies determined and of the estimated or measured discharge temperature of the compressor.

According to a further particular feature, the thermodynamic module is arranged for the determination of the flow rate of coolant fluid through the compressor on the basis of the volumetric mass of the coolant fluid, of the command function of the compressor, and of a function for the high pressure value and the low pressure value.

According to a further particular feature, the thermodynamic module is arranged for the determination of the thermal capacity of the condenser, and of the thermal capacity of the evaporator, on the basis of the flow rate of coolant fluid and the enthalpies determined at the four points of measurement.

According to a further particular feature, the command and processing unit comprises an electrical module which is arranged for the determination of the electric power input of the compressor, on the basis of the flow rate of coolant fluid and of the enthalpies determined.

According to a further particular feature, the command and processing unit comprises an electrical module which is arranged for the determination of the electric power input of each ventilator in the air condenser, on the basis of the command function applied to each ventilator.

According to a further particular feature, the command and processing unit comprises an electrical module which is arranged for the determination of the electric power input of each pump used for the circulation of the heat transfer fluid, on the basis of the command function applied to each pump.

According to a further particular feature, the system comprises a diagnostic analysis module which is arranged for the determination of an instantaneous performance coefficient for the system, on the basis of the thermal capacity and of the electrical capacity of the system.

### BRIEF DESCRIPTION OF DIAGRAMS

Further characteristics and advantages will become evident from the following detailed description, with reference to the attached diagrams, in which:

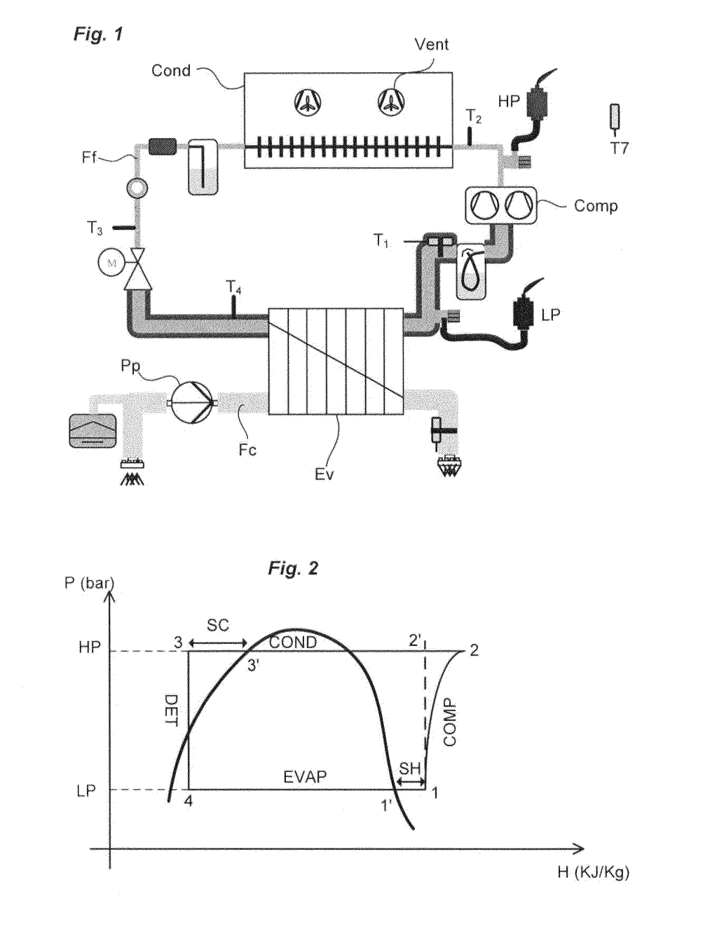

FIG. 1 shows a schematic representation of a heating, ventilation and air-conditioning system,

FIG. 2 shows an enthalpic diagram for the illustration of the operating principle of the thermodynamic module,

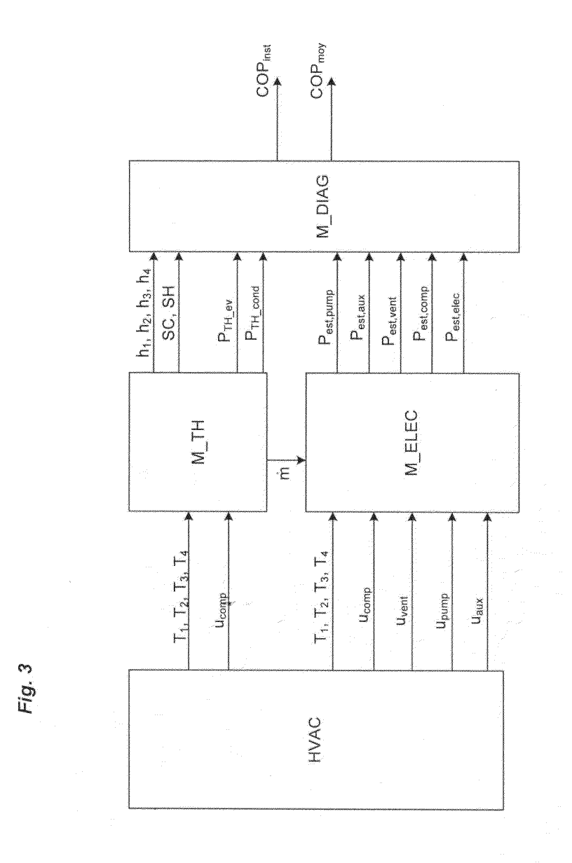

FIG. 3 shows a schematic representation of the system according to the invention.

### DETAILED DESCRIPTION OF AT LEAST ONE FORM OF EMBODIMENT

The invention relates to the detection of faults in a heating, ventilation and air-conditioning system (HVAC).

With reference to FIG. 1, a system of this type is essentially comprised of the following:
An air condenser Cond for the conversion of a coolant fluid Ff from the gaseous state to the liquid state. The air condenser Cond may be e.g. of tube and fin type or of microchannel type, and may comprise one or more ventilators Vent for the conveyance of air through the air condenser Cond, thereby ensuring the condensation of the coolant fluid Ff.
An expansion device Det for the let-down of pressure of the coolant fluid Ff.
An evaporator Ev for the conversion of the coolant fluid Ff from the gaseous+liquid state to the gaseous state. The evaporator Ev is also permeated by a heat transfer fluid Fc, such as air or glycolated water, which exchanges its heat energy with the coolant fluid Ff and is heated or cooled accordingly.
One or more compressors Comp for the intake of the coolant fluid Ff from the evaporator Ev in the gaseous state, and the delivery thereof to the air condenser Cond. Compressors may be controlled e.g. by one or more command units.
One or more circulation pumps Pp for the circulation of the heat transfer fluid Fc through the evaporator Ev.

The method according to the invention allows the execution of a diagnostic analysis of a system of this type, in a non-intrusive manner, i.e. without the necessity for the shutdown of the system, and using a limited number of sensors. The inclusion of additional sensors will allow the execution of a more advanced diagnostic analysis. The solution according to the invention allows the execution of predictive maintenance, and is compatible with any type of heating, ventilation and air-conditioning system.

The method according to the invention is deployed by means of a diagnostic analysis system which is appropriate to the heating, ventilation and air-conditioning system.

According to the invention, the system is provided with a minimum of three temperature sensors, positioned in the system as follows:
one temperature sensor (T₁) for the measurement of the temperature of the coolant fluid Ff at the compressor intake (point 1 on FIG. 2),
one temperature sensor (T₃) for the measurement of the temperature of the coolant fluid at the inlet to the expansion device (point 3 on FIG. 2),
one temperature sensor (T₄) for the coolant fluid Ff at the outlet of the expansion device (point 4 on FIG. 2).

If necessary, an additional temperature sensor may be used. This temperature sensor (T₂) is used for the measurement of the temperature of the coolant fluid Ff at the compressor discharge (point 2 on FIG. 2).

The system also comprises a command and processing unit, which is configured for the execution of a thermodynamic module M_TH for the determination of thermodynamic parameters in the system, and an electrical module M_ELEC for the determination of electrical parameters in the system.

On the basis of the three temperature measurements, together with the command function of compressors, the thermodynamic module M_TH is able to determine the enthalpies h₁, h₂, h₃, h₄ of the coolant fluid Ff at point 1, point 2, point 3 and point 4. FIG. 2, which shows an enthalpic diagram for a coolant fluid Ff, illustrates the reasoning applied by the thermodynamic module M_TH. This diagram represents the changes in the coolant fluid Ff in the system, as a function of its absolute pressure (in bar) and enthalpy (in kJ/kg).

Method for the Calculation of the Flow Rate of Coolant Fluid in a Compressor

The flow rate of coolant fluid in a compressor is given by the following formula:

{dot over (\hat{m}_{comp}=u_{comp}×ρ(T₁,P₁)×f(P₁,P₂)

Where:
{dot over (\hat{m}_{comp} is the estimated flow rate of coolant fluid flowing in a compressor,
u_{comp} is the command function of the compressor, expressed in % (0% -100%),
ρ(T¹,P₁) is the volumetric mass (in kg/m³) of the coolant fluid at the inlet of the compressor unit (point 1),
f(P₁,P₂) is the volumetric efficiency function of the compressor: this is a polynomial function of 2 variables (the low pressure P₁ (=LP) and the high pressure P₂ (=HP)), i.e.:

f(P₁,P₂)=a₀+a₁×P₁+a₂×P₂+a₃×P₁²+a₄×P₁×P₂+a₅×P₂²

The coefficients a₀, a₁, a₂, a₃, a₄, a₅ may be determined:
by the manufacturer,
from data tables supplied by the compressor manufacturer, by the application of a least square method to identify a polynomial function which approximates most closely to the data concerned,
from measurements taken using an ultrasonic flow meter fitted to a compressor, from which the retrieval of technical data is not possible.

The total flow rate of coolant fluid circulating in a coolant fluid circuit (condenser, expansion device and evaporator) is equal to the sum of all flows circulating in all compressors.

$$\hat{\dot{m}} = {\sum }_{i = 1}^{nb\_compressors} {\hat{\dot{m}}}_{comp , i}$$

Method for the Calculation of Enthalpy at a Compressor Outlet

For this purpose, the thermodynamic module M_TH will firstly determine the entropy at point 1:

s₁(T₁,P₁)

Based on the assumption of isentropic conversion, entropy at the compressor outlet (if conversion is isentropic) will be equal to entropy at its inlet:

s_{2,isent,comp}=s₁(T₁,P₁)

From s_{2,isent,comp} and the high pressure P₂ estimated beforehand, the thermodynamic module M_TH will determine the enthalpy of isenthalpic conversion:

h_{2,isent,comp}=h(s_{2,isent,comp},P₂)

The thermodynamic module M_TH calculates isentropic efficiency as a function of T₁, P₁ and P₂:

η_{isent,comp}=b₀+b₁×T₁+b₂×τ+b₃×T₁²+b₄×T₁×τb₅×τ²

Where τ is the compression ratio of the compressor:

$$τ = \frac{{P}_{2}}{{P}_{1}}$$

and the coefficients b₀,b₁,b₂,b₃,b₄,b₅ are determined on the basis of data supplied by the manufacturer.

The thermodynamic module M_TH then determines enthalpy at the compressor outlet:

$${h}_{2 , comp} = {h}_{1} + \frac{( {h}_{2 , isent , comp} - {h}_{1} )}{{η}_{isent , comp}}$$

Method for the Calculation of Enthalpy at Point 2

Where the system comprises multiple compressors, the thermodynamic module M_TH determines the enthalpy h₂ at point 2 from the barycentre of all output enthalpies for each compressor, weighted by the flow rate of coolant fluid in each compressor.

$${h}_{2} = {\sum }_{i = 1}^{nb\_compressors} {λ}_{i} \times {h}_{2 , comp , i} where {λ}_{i} = \frac{{\hat{\dot{m}}}_{comp , i}}{{\sum }_{k = 1}^{n} {\hat{\dot{m}}}_{comp , k}}$$

Method for the Evaluation of the Coolant Fluid Temperature at Point 2

From calculations completed previously, the thermodynamic module M_TH can determine an estimated temperature at point 2, without the use of sensors. The thermodynamic module M_TH determines the temperature at point 2 as a function of the enthalpy h2 and the high pressure P2.

T_{2,est}=T₂(h₂,P₂)

Method for the Evaluation of Sub-Cooling

From T₁, T₂, T₃ ,T₄ and the states of the various actuators, it is not possible to directly determine sub-cooling, designated as “SC”.

The thermodynamic module M_TH therefore generates an assumption for this sub-cooling SC, as a function of the type of thermal system used (e.g. it is assumed that SC=0K), and the thermodynamic module M_TH executes calculations accordingly. The thermodynamic module thus determines an estimated temperature T_{2,est} at point 2. If a temperature sensor is present at point 2, the thermodynamic module M_TH compares the estimated temperature T_{2,est} with the actual temperature T₂ measured at point 2. The thermodynamic module can then refine the value of sub-cooling SC by effecting the convergence of the calculated value for the estimated temperature T_{2,est} at point 2 towards the actual temperature T₂.

The error ε_{T}_{₂}=|T_{2,est}−T₂| must therefore be minimal, and convergent towards zero.

For example, the thermodynamic module will scan values for sub-cooling from 0K to 20K (in increments of 0.1K).

From the selected value for sub-cooling, the temperature measurements T₁, T₂, T₃, T₄ and the command function for compressors, with reference to FIG. 2, the thermodynamic module M_TH will calculate the following in succession:
The pressure at point 3, a function of the measured temperature T₃ and the sub-cooling value selected:

P₃=P₃(T₃+SC)
The enthalpy at point 3, a function of the temperature T₃ and pressure P₃:

h₃=h₃(T₃,P₃)
The enthalpy at point 4, equal to the enthalpy determined at point 3:

h₄=h₃
The pressure at point 4, a function of the measured temperature T₄ and the enthalpy h₄: P₄=P₄(T₄,h₄)
The pressure at point 1, equal to the pressure P₄ at point 4:

P₁=P₄
The enthalpy at point 1, a function of the measured temperature T₁ and the pressure P₁ determined:

h₁=h₁(T₁,P₁)
The entropy at point 1, a function of the measured temperature T₁ and the pressure P₁ determined:

s₁=s₁(T₁,P₁)
The volumetric mass (in kg/m³) of the coolant fluid Ff at the inlet to the compressor unit (point 1):

ρ₁=ρ₁(T₁,P₁)
The temperature value T_{1,sat} at point 1′, a function of the pressure P₁:

T_{1,sat}=T_{1,sat}(P₁)
The value of superheating SH, a function of the measured temperature T₁ and the temperature T_{1,sat} at point 1′:

SH=T₁−T_{1,sat}
The flow rate of coolant fluid Ff in all compressors, as described above:

{dot over (\hat{m}_{comp,i}=u_{comp,i}×ρ(T₁,P₁)×f(P₁,P₂), ∀i ∈ {1 . . . nb_comp}
The output enthalpy of each compressor, as described above:

h_{2,comp,i}, ∀i ∈ {1 . . . nb_comp}
The enthalpy at point 2, as described above:

$${h}_{2} = {\sum }_{i = 1}^{nb\_compressors} {λ}_{i} \times {h}_{2 , comp , i} where {λ}_{i} = \frac{{\hat{\dot{m}}}_{comp , i}}{{\sum }_{k = 1}^{n} {\hat{\dot{m}}}_{comp , k}}$$

The estimated temperature T_{2,est} at point 2, a function of the enthalpy at point 2 and the pressure at point 2:

T_{2,est}=T₂(h₂,P₂)
The error to be corrected between the estimated temperature at point 2 and the actual temperature measured:

ε_{T}_{₂}=|T_{2,est}−T₂|

The thermodynamic module corrects the value for sub-cooling SC, until the error to be corrected between the estimated temperature at point 2 and the measured temperature at point 2 reaches its minimum value.

In the interests of greater accuracy and robustness, the system may also incorporate sensors for the measurement of low pressure (LP) and high pressure (HP).

Where the flow rate of coolant fluid through the compressor Comp is known, the thermodynamic module M_TH can also determine thermal capacities.

For the condenser:

P_{TH}_{_{—}}_{cond}=(h¹−h₃)×m

Where h₂ is the output enthalpy of the compressor (point 2), h₃ is the output enthalpy of the expansion device (point 3) and \dot{m} is the flow rate of coolant fluid in the compressor.

For the evaporator:

P_{TH}_{_{—}}ₑᵥ=(h₁−h₃)×\dot{m}

Where h₁ is the input enthalpy of the compressor (point 1), h₃ is the output enthalpy of the expansion device (point 3) and \dot{m} is the flow rate of coolant fluid in the compressor.

The system also comprises an electrical module M_ELEC, which is used for the determination of the following parameters:
the electric power input P_{est,comp} of the compressor Comp,
the electric power input P_{est,pump} of each pump Pp used for the circulation of the heat transfer fluid Fc.
the electric power input P_{est,vent} of each ventilator Vent in the condenser Cond,
the electric power input P_{est,aux} of each auxiliary.

For the determination of these parameters, the system will require additional inputs to the temperatures measured by sensors. These additional inputs are the command function of the compressor u_{comp}, the command function of the ventilators uᵥₑₙₜ, the command function of each pump uₚᵤₘₚ and the command function of each auxiliary. These command functions are generated by the command units of the constituent elements of the system, and are applied at the input of the electrical module M_ELEC.

For a compressor:

P_{est,comp}=(h₂−₁)×\dot{m}

Where h₁ is the input enthalpy of the compressor (point 1), h₂ is the output enthalpy of the compressor (point 2) and \dot{m} is the flow rate of coolant fluid circulating in the compressor.

For a ventilator:

P_{est,vent}=g(uᵥₑₙₜ)

Where uᵥₑₙₜ is the command function of the ventilator and g is a characteristic function for the properties of the combination of ventilators+the aeraulic circuit (which may be reduced to a single heat-exchanger).

It may be assumed that this function is equal to the cube of the command function of the ventilator.

g(uᵥₑₙₜ)=g₀×uᵥₑₙₜ³

g₀ may be determined:
from the data plate of the ventilator (in which case, the impact of the heat-exchanger will be ignored),
from the characteristics of the ventilator (load curves, efficiency, etc.) and the characteristics of the heat-exchanger used for the calculation of load losses (number of fins, size of fins, number and size of tubes, etc.),
from one or more short-term electrical measurements at different operating speeds (where a variable speed drive is fitted).

In the last 2 cases, the model for the power consumption of the ventilator may be refined e.g. by the application of the following function, or by the application of a polynomial function of a higher degree:

g(uᵥₑₙₜ)=g₁×uᵥₑₙₜ+g₂×uᵥₑₙₜ²+g₃×uᵥₑₙₜ³

The total power input for all ventilators will be equal to the sum of all the power inputs for each ventilator:

$${P}_{est , vent} = {\sum }_{i = 1}^{nb\_ventilators} {P}_{est , ventilator , i}$$

For a pump:

P_{est,pump}=h(uₚᵤₘₚ)

Where uₚᵤₘₚ is the command function of the pump and h is a characteristic function for the properties associated with the combination of the pump+the hydraulic circuit.

It may be assumed that this function is equal to the cube of the command function of the pump.

h(uₚᵤₘₚ)=h₀×uₚᵤₘₚ³

h₀ may be determined:
from the data plate of the pump (in which case, the impact of the hydraulic circuit will be ignored),
from the characteristics of the pump (load curves, efficiency, etc.) and the characteristics of the hydraulic circuit used for the calculation of load losses (length and diameter of pipes, the number of bends, valves and heat-exchangers present on the system, the height of the building, etc.),
from one or more short-term electrical measurements at different operating speeds (where a variable speed drive is fitted).

In the last 2 cases, the model for the power consumption of the pump may be refined by the application of the following function, or by the application of a polynomial function of a higher degree:

h(uₚᵤₘₚ)=h₁×uₚᵤₘₚ+h₂×uₚᵤₘₚ²+h₃×uₚᵤₘₚ³

The total power input for all pumps will be equal to the sum of all the power inputs for each pump:

$${P}_{est , pumps} = {\sum }_{i = 1}^{nb\_pumps} {P}_{est , pump , i}$$

For auxiliaries:

For the calculation of electric power input, the electrical module M_ELEC considers data provided by technical documentation, or by specific electrical measurements.

For example, for the evaluation of the electric power input of the anti-freeze resistor, the electrical module M_ELEC will firstly log its power rating (as indicated on the data plate), then retrieve its command function Uₐᵤₓ (contactor status) in order to determine whether or not the resistor is in service.

The total electric power rating P_{est,elec} is determined by the electrical module M_ELEC by the addition of the electric power ratings determined for each constituent element of the system.

P_{est,elec}=P_{est,comp}+P_{est,vent}+P_{est,pumps}+P_{est,aux}+ . . .

Naturally, estimated power ratings might be replaced by measurements recorded using power sensors (power meters). It is also possible to use a combination of measured power values and calculated power values.

The system also comprises a diagnostic analysis module M_DIAG for the determination of various diagnostic indicators.

A first diagnostic indicator corresponds to the instantaneous performance coefficient COPᵢₙₛₜ, which is defined as follows:

$${COP}_{inst} = \frac{{P}_{therm}}{{P}_{est , elec}}$$

Pₜₕₑᵣₘ is the useful thermal power generated by the system.

Where the system is generating cold:

Pₜₕₑᵣₘ=P_{TH}_{_{—}}ₑᵥ

Where the system is generating heat:

Pₜₕₑᵣₘ=P_{TH}_cond

P_{est,elec} is the instantaneous electric power input of the system, as already defined above.

A second diagnostic indicator corresponds to an average performance coefficient, which is expressed as follows:

$${COP}_{moyen} = \frac{{E}_{therm}}{{E}_{elec}} where {E}_{therm} = \int {P}_{therm} and {E}_{elec} = \int {P}_{est , elec}$$

(where a digital calculator is used, such as a programmable automatic controller, the integral will be replaced by a finite sum).

The average performance coefficient may be calculated over variable time windows: time windows of 1 second, 1 minute, 1 hour, 1 day, 1 week, 1 month, etc.

1. Diagnostic analysis method for a heating, ventilation and air-conditioning system, wherein said system comprises at least one compressor (Comp) connected to an air condenser (Cond) and designed for the circulation of a coolant fluid (Ff), an evaporator (Ev) connected to the air condenser (Cond) via an expansion device (Det) and permeated by a heat transfer fluid (Fc), wherein said air condenser comprises at least one ventilator (Vent), said method being characterized in that it involves:
the measurement of the following:
the coolant fluid temperature (T₁) at the compressor intake,
the coolant fluid temperature (T₃) at the inlet of the expansion device,
the coolant fluid temperature (T₄) at the outlet of the expansion device,
the determination or measurement of the discharge temperature (T₂) of the compressor, and
the determination of the following, on the basis of temperature measurements at the compressor intake, at the inlet of the expansion device and at the outlet of the expansion device, of the measured or estimated discharge temperature of the compressor, of the compressor command function (u_{comp}) and a thermodynamic module (M_TH):
enthalpies of the system at the compressor intake, the compressor discharge, at the inlet of the expansion device and at the outlet of the expansion device,
the superheating of the system.

2. Method according to claim 1, characterized in that it involves the determination of the sub-cooling (SC) of the system on the basis of temperature measurements (T₁-T₃) at the compressor intake, at the compressor discharge, at the inlet to the expansion device, at the outlet of the expansion device, and of the enthalpies determined (h₁-h₄).

3. Method according to claim 1, characterized in that it involves the determination of values for low pressure (LP) and high pressure (HP) which are characteristic of the enthalpic diagram of the system, on the basis of temperature measurements (T₁-T₃) at the compressor intake, at the inlet to the expansion device, at the outlet of the expansion device, of the enthalpies determined and of the estimated or measured discharge temperature (T2) of the compressor.

4. Method according to claim 1, characterized in that it involves a stage for the determination of the flow rate of coolant fluid through the compressor on the basis of the volumetric mass of the coolant fluid (FF), of the compressor command function (u_{comp}) and of a function for the high pressure value (HP) and the low pressure value (LP).

5. Method according to claim 4, characterized in that it involves a stage for the determination of the thermal capacity of the condenser (P_{TH}_{_{—}}_{cond}), and of the thermal capacity of the evaporator (P_{TH}_{_{—}}ₑᵥ), on the basis of the flow rate of coolant fluid and of the enthalpies determined at the four points of measurement.

6. Method according to claim 5, characterized in that it involves a stage for the determination of the electric power input of the compressor, on the basis of the flow rate of the coolant fluid and of the enthalpies determined.

7. Method according to claim 6, characterized in that it involves a stage for the determination of the electric power input of each ventilator in the air compressor, on the basis of the command function (uᵥₑₙₜ) applied to each ventilator.

8. Method according to claim 7, characterized in that it involves a stage for the determination of the electric power input of each pump (Pp) for the circulation of the heat transfer fluid (FC), on the basis of the command function (Upump) applied to each pump.

9. Method according to claim 8, characterized in that it involves a stage for the determination of an instantaneous performance coefficient (COPᵢₙₛₜ) on the basis of the thermal capacity of the system and of the electrical capacity of the system.

10. System for the diagnostic analysis of a heating, ventilation and air-conditioning system, wherein said system comprises at least one compressor (Comp) connected to an air condenser (Cond) and designed for the circulation of a coolant fluid (Ff), an evaporator (Ev) connected to the air condenser (Cond) via an expansion device (Det) and permeated by a heat transfer fluid (Fc), wherein said air condenser comprises at least one ventilator (Vent), said system being characterized in that it comprises:
a temperature sensor for the coolant fluid at the compressor intake,
a temperature sensor for the coolant fluid at the compressor discharge,
a temperature sensor for the coolant fluid at the inlet of the expansion device,
a temperature sensor for the coolant fluid at the outlet of the expansion device,
a command and processing unit, comprising a thermodynamic module which is arranged for the determination of the following, on the basis of temperature measurements and the command function of the compressor:
enthalpies of the system at the four temperature measuring points,
the superheating of the system.

11. System according to claim 10, characterized in that the thermodynamic module is arranged for the determination of the sub-cooling (SC) of the system on the basis of temperature measurements (T₁-T₃) at the compressor intake, at the compressor discharge, at the inlet of the expansion device, at the outlet of the expansion device, and of the enthalpies determined (h₁-h₄).

12. System according to claim 10, characterized in that the thermodynamic module is arranged for the determination of values for low pressure (LP) and high pressure (HP) which are characteristic of the enthalpic diagram of the system, on the basis of temperature measurements (T₁-T₃) at the compressor intake, at the inlet to the expansion device, at the outlet of the expansion device, of the enthalpies determined and the estimated or measured discharge temperature (T₂) of the compressor.

13. System according to claim 10, characterized in that the thermodynamic module is arranged for the determination of the flow rate of coolant fluid through the compressor on the basis of the volumetric mass of the coolant fluid (Ff), of the command function of the compressor (u_{comp}), and of a function for the high pressure value (HP) and the low pressure value (LP).

14. System according to claim 13, characterized in that the thermodynamic module is arranged for the determination of the thermal capacity of the condenser, and of the thermal capacity of the evaporator, on the basis of the flow rate of coolant fluid and of the enthalpies determined at the four points of measurement.

15. System according to claim 14, characterized in that the command and processing unit comprises an electrical module (M_ELEC) which is arranged for the determination of the electric power input of the compressor, on the basis of the flow rate of coolant fluid and of the enthalpies determined.

16. System according to claim 15, characterized in that the command and processing unit comprises an electrical module which is arranged for the determination of the electric power input of each ventilator in the air condenser, on the basis of the command function (uᵥₑₙₜ) applied to each ventilator.

17. System according to claim 16, characterized in that the command and processing unit comprises an electrical module which is arranged for the determination of the electric power input of each pump used for the circulation of the heat transfer fluid (Fc), on the basis of the command function (uₚₒₘₚₑ) applied to each pump.

18. System according to claim 17, characterized in that it comprises a diagnostic analysis module which is arranged for the determination of an instantaneous performance coefficient (COPᵢₙₛₜ) for the system, on the basis of the thermal capacity and the electrical capacity of the system.
